(19) United States
(12) Patent Application Publication
(10) Pub. No.: US 2018/0099185 A1
(43) Pub. Date: Apr. 12, 2018

(54) RETAIL SHOPPING FACILITY WORKOUT SYSTEMS AND METHODS

(71) Applicant: Wal-Mart Stores, Inc., Bentonville, AR (US)

(72) Inventors: Matthew A. Jones, Bentonville, AR (US); Nicholaus A. Jones, Fayetteville, AR (US)

(21) Appl. No.: 15/782,060

(22) Filed: Oct. 12, 2017

Related U.S. Application Data
(60) Provisional application No. 62/407,185, filed on Oct. 12, 2016.

(51) Int. Cl. A63B 24/00; B62B 5/00; G06F 19/00; H04W 4/00; G01C 21/20; A63B 21/06

(52) U.S. Cl. CPC A63B 24/0062; B62B 5/0026; G06F 19/3481; A63B 21/06; G01C 21/206; A63B 24/00; H04W 4/008

(57) ABSTRACT

In some embodiments, systems and methods provide a customer controlled cart workout. Some systems, comprise: a cart coordination control circuit; a shopping cart comprising a cart control system, a wireless transceiver and a resistance modification system configured to adjust a resistance level corresponding to different amounts of force to be applied in physically moving the cart along a surface; wherein the cart coordination control circuit is configured to: associate the shopping cart with a first identified customer; wirelessly communicate with a first user interface unit associated with the first customer; receive, through a cart resistance control software application (APP) operated on the first user interface unit, a resistance control instruction specifying a modification to the resistance level; and communicate a resistance adjustment instruction to the cart control system causing the resistance modification system to adjust the resistance level applied to the shopping cart.

### CROSS-REFERENCE TO RELATED APPLICATIONS

This application claims the benefit of U.S. Provisional Application No. 62/407,185, filed Oct. 12, 2016, which is incorporated herein by reference in its entirety.

### TECHNICAL FIELD

This invention relates generally to enabling customers to workout at shopping facilities.

### BACKGROUND

Customer loyalty can be critical to retail facilities success. Through customer loyalty a retail facility can achieve repeat visits and purchases by customers. There is a need to improve customer experiences at retail shopping facilities to improve customer loyalty.

### BRIEF DESCRIPTION OF THE DRAWINGS

Disclosed herein are embodiments of systems, apparatuses and methods that track products during transport. This description includes drawings, wherein:

FIG. 1 illustrates a simplified block diagram of an exemplary customer controlled cart workout system, in accordance with some embodiments.

FIG. 2A illustrates a simplified block diagram of an exemplary shopping cart system or other customer movable product transport system, in accordance with some embodiments.

FIG. 2B illustrates a simplified plane view of an exemplary shopping cart system, in accordance with some embodiments.

FIG. 3 illustrates an exemplary system for use in implementing methods, techniques, devices, apparatuses, systems, servers, sources and providing customer controlled workout at a shopping facility, in accordance with some embodiments.

FIG. 4 illustrates a simplified flow diagram of an exemplary process of providing customers with a workout while shopping, in accordance with some embodiments.

FIG. 5 illustrates a simplified flow diagram of an exemplary process to enable customers to perform a workout while at a shopping facility, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein to enable customer workouts at retail shopping facilities. The system includes a central cart coordination system in wirelessly communication with multiple shopping carts of one or more shopping facilities that each include a cart control system, a wireless transceiver and a resistance modification system. The resistance modification system is configured to adjust a resistance level corresponding to different amounts of force to be applied in physically moving the cart along a surface. In some embodiments, the cart coordination system is configured to associate a particular shopping cart with an identified customer, and to wirelessly communicate with a user interface unit associated with the customer. The user interface unit can be substantially any relevant mobile device that can wirelessly communication with the cart coordination system, such as a smartphone, cellular phone, tablet, laptop, smartwatch, wearable exercise system, and/or other such user interface units. The cart coordination system further receives, through a cart resistance control and/or fitness software application (APP) operated on the customers' user interface unit, a resistance control instruction specifying a modification to a resistance level to be applied by the resistance modification system on the associated cart. In response, the cart coordination system can communicate a resistance adjustment instruction to the cart control system causing the resistance modification system to adjust the resistance level applied to the shopping cart.

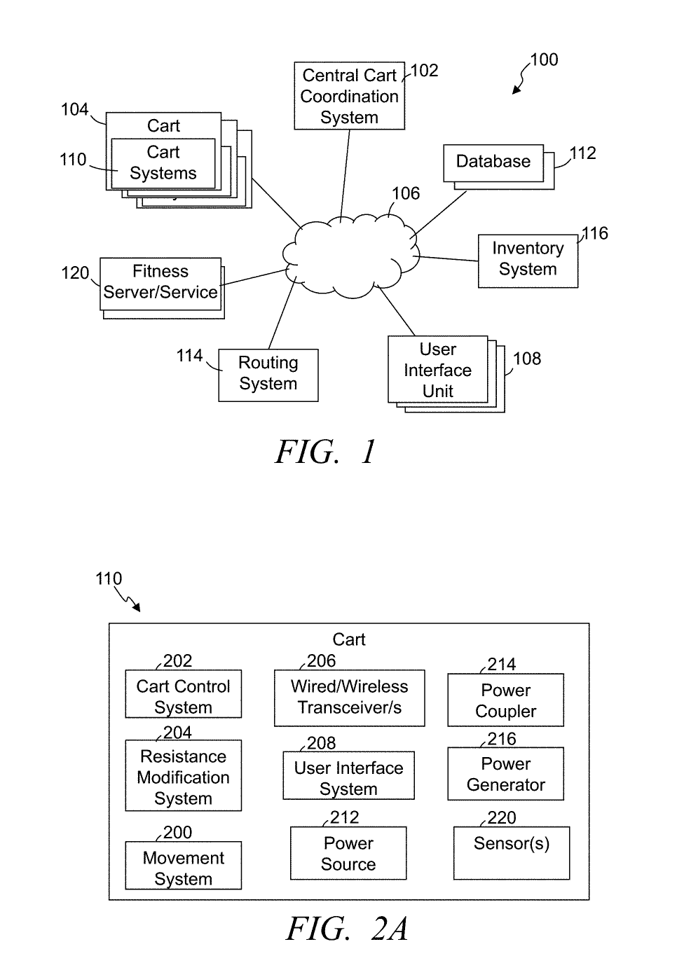

FIG. 1 illustrates a simplified block diagram of an exemplary customer controlled cart workout system 100, in accordance with some embodiments. The system includes one or more central cart coordination systems 102 and multiple shopping cart 104 with cart control systems 110 that in part enable customers to control the resistance of a shopping cart as the customer pushes the cart through and proximate a shopping facility. The cart coordination system is configured to communicate with at least cart systems through one or more wireless and/or wired communication and/or computer networks 106 (Ethernet, Wi-Fi, Bluetooth, cellular, Internet, etc.). Some embodiments further include and/or the cart coordination system is in communication with one or more databases 112, such as customer profile databased, exercise routine databases, exercise history database, inventory database, other such databases, and typically a combination of two or more of such databases.

In some embodiments, the system further includes a routing system 114, which may be part of the cart coordination system or communicatively coupled with the cart coordination system. The routing system is configured to determine one or more routes through a respective shopping facility where a customer is shopping and/or exercising. The shopping facility may, in some instances, be a retail sales facility, a fulfillment center, or other type of facility in which products are sold and/or distributed to customers. The facility may be any size or format, and may include products from one or more merchants. For example, a facility may be a single store operated by one merchant, a chain of two or more stores operated by one entity, or may be a collection of stores covering multiple merchants.

Further, some embodiments include an inventory system 116 that tracks inventory counts and/or locations of thousands of products offered for sale at one or more shopping facilities. The cart coordination system, cart systems, and/or other components of the cart workout system 100 may further be in wired and/or wireless communication with one or more user interface units 108 that are associated with customers and workers of the shopping facility. The user interface units can be a smartphone, laptop, tablet, computer, shopping facility specific electronics device (e.g., product and/or product identifier scanner, imaging system, etc.), and other such systems. In some embodiments, the cart coordination system includes or is in communication with one or more fitness servers or services 120 that can, in some instances, supply workout routines, evaluate workout statistics and provide workout feedback to the cart coordination system, and/or other such services.

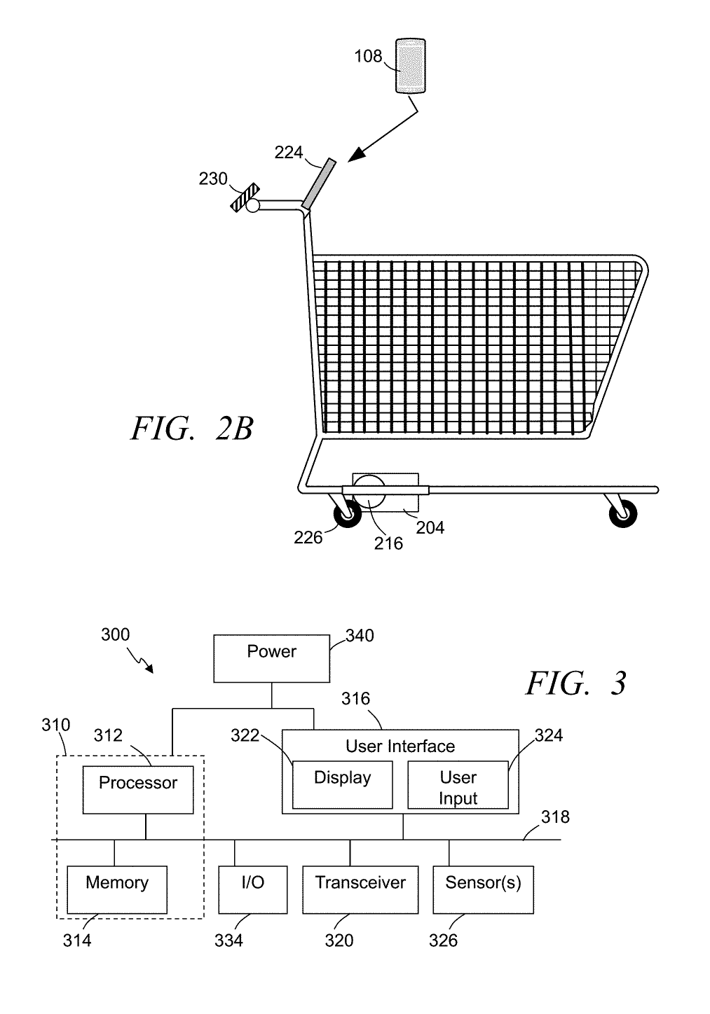

FIG. 2A illustrates a simplified block diagram of an exemplary shopping cart system 110 or other customer movable product transport system, in accordance with some embodiments. FIG. 2B illustrates a simplified plane view of an exemplary shopping cart 104 and cart system 110, in accordance with some embodiments. Referring to FIGS. 1-2B, the cart system 110 cooperates with a shopping cart or other customer movable device that is pushed, pulled and/or carried by a customer. The below is described with reference to shopping carts that have wheels as the movement system 200 and a product bin to receive products, and is configured to be pushed by a customer. However, it will be appreciated by those skilled in the art that other customer movable devices can be used and/or the cart system can include other types of movement systems (e.g., tractor like treads, etc.) can be utilized.

The cart system includes at least one cart control system 202 that couples with and provides control signals to one or more resistance modification systems 204 that are configured to modify the resistance of movement of the cart system. The cart system further includes one or more wireless and/or wired communication transceivers 206. In some embodiments, the cart system may include one or more user interface systems 208 and power source 212. Some implementations may further include one or more power couplers 214 and power generators 216. Typically, the cart system additionally includes one or more sensors 220, such as but not limited to a resistance level, speed, distance, location (e.g., GPS, inertial sensor, wireless network antenna and/or wireless network access node triangulation, cellular communication triangulation, bar code reader, encoded light signal detector, etc.), weight of products, product sensors (e.g., bar code reader, radio frequency identifier (RFID) tag reader, image capture and processing, etc.), heart rate monitor system, perspiration sensor, other such sensors, or combination of two or more of such sensors.

In some embodiments, the cart system 110 further includes one or more mounting or docking stations 224 that allows a customer to position her/his user interface unit 108. For example, the docking station may be mounted to a handle or push bar, the basket, or other location that is visible to the customer. Further, the docking station may be mounted on a pivot to allow the customer to orient the user interface unit to a desired position and/or rotate the user interface unit (e.g., when the customer moves away from the handle, such as when performing one or more exercises instructed by the workout route (e.g., push-ups, lunges, squats, etc.), retrieving one or more products, and/or other actions). The docking station may be coupled with the power source 212 to receive power that can be used to supply power to the user interface unit 108 while in the docking station. Further, in some instance the docking station may be communicatively coupled with the cart control system 202 enabling direct wired communication between the user interface unit and the cart control system. In other instances, however, the user interface unit may establish a wireless communication with the cart control system, such as via Bluetooth, Wi-Fi, cellular, or other such relevant wireless communication protocols.

The resistance modification system 204 can, in some examples, cooperate with one or more wheels 226, axles, or the like. Further, in some implementations the resistance modification system couples with and/or includes one or more power generators 216. The resistance level can apply greater resistance to the one or more wheels and/or generator (which may provide for increased power generation). Some embodiments include a manual resistance level adjustment system 230. The adjustment system 230 may be a physical adjustment system, such as a knob that is rotated. In other instances, the adjustment system may include one or more buttons, scroll wheels, or other such indicators to cause the adjustment of the resistance level. For example, in some applications the adjustment system may be implemented in part through the user interface system 208. Some embodiments additionally or alternatively enable a customer to provide resistance adjustment through the APP on the user interface unit 108.

The resistance modification system 204 is configured to adjust a resistance level corresponding to different amounts of force to be applied in physically moving the cart along a surface at or proximate a shopping facility. The resistance can be applied through controlled breaking, control tension, magnetics, other such resistance controlled mechanisms, or combination of two or more resistance control systems. In some embodiments, the resistance modification system is coupled with and/or includes a power generator that generates electrical power as the customer pushes the cart. The adjusted resistance can increase and decrease power generation per distance traveled. The generated power may be stored in the power source 212, which can be used to power at least components of the cart system 110. Excess power may be supplied to an external power storage and/or used for other systems, such as when the cart is positioned into a cart corral, which may establish an electrical connection through the power coupler 214. In some embodiments, the APP and/or cart coordination system may track the quantity of power generated and/or track the workout performed and provide points, discounts and/or other incentives to the customer based on the generated power, workout, levels of resistance and/or other such statistics, as an incentive to utilize the workout functionality and a healthy lifestyle. Additionally or alternatively, power may be supplied to the cart system through the power coupler, such as when the cart has not been used by a customer for a threshold period of time and/or when a power level of the power source 212 is below a threshold while the cart is in the cart corral or other location with the power coupler 214 coupled to a power source. The cart coordination system 102 and/or the cart control system 202 can control the operation of the resistance modification system to increase and decrease resistance in accordance with a workout routine, instructions received from a customer, instructions received from a shopping facility system, or other system. Further, the cart control system and/or the cart coordination system utilizes sensor data from the one or more sensors 220 of the cart and/or one or more other carts in controlling the resistance.

In some embodiments, the cart coordination system associates a particular shopping cart with a particular identified customer. The customer may be identified based on a communication from the customer's user interface unit 108, through interaction with the cart control system (e.g., a customer identifier received through the user interface system 208, a scan of a customer card, etc.), through a cart registration kiosk, RFID detection of an RFID tag associated with the customer, other such identifiers, or combination of such identifiers. For example, in some applications a customer may use their user interface unit 108 to scan a bar code of a cart that is communicated to the cart coordination system and the cart coordination system can identify the customer based on identifying information in the communication (e.g., phone number, media access control (“MAC”) address, unique device identifier, similar unique identifying code, or the like). Further, in some embodiments, the user interface unit may implement a software application (APP) that the customer can activate that directs the customer regarding associating a cart with the customer (e.g., the APP directs the customer to capture an image of a bar code on the shopping cart, and in response the APP cause the bar code or information obtained based on the bar code along with an identifier, which may be based on the APP, to the cart coordination system). In some implementations, for example, the cart coordination system may receive, through a cart resistance control APP operating on a customer's user interface unit 108, a cart identifier of the shopping cart, and can implement the association of the identified shopping cart with the customer based on the received cart identifier.

The cart coordination system can further wirelessly communicate with user interface units associated with one or more customers utilizing carts and/or wirelessly communicates with one or more cart control systems being utilized by customers. The cart coordination system can receive one or more instructions, through a cart resistance control APP operated on the user interface units and/or through the cart control system. For example, a customer may issue a request and/or instruction to activate the resistance modification system. Further, a customer can cause one or more resistance control instructions to be communicated, through the APP, to the cart coordination system specifying a modification to the resistance level, requesting a selected workout routine, requesting details about a workout routine, a selected workout level, and/or other such inputs. Based on a received instruction the cart coordination system can communicate one or more instructions to the cart control system 202 to be implemented by the cart control system. For example, based on the received instruction to adjust a resistance level, the cart coordination system can communicate a resistance adjustment instruction to the cart control system 202 to cause the resistance modification system to adjust the resistance level applied to the shopping cart.

In some embodiments, the APP provides a user interface to the customer allowing the customer to select various options, issue one or more commands that are communicated to the cart coordination system 102 and/or the cart control system 202, access data that may be maintained by the APP and/or received from the cart coordination system and/or the cart control system, and perform other actions. For example, the customer may access one or more sets of predefined workout routines, may access one or more sets of resistance or difficulty levels, may access one or more sets of route options, and/or other such options. As a further example, the cart coordination system may receive, though a cart control APP, a selection of a first preset workout routine selected from multiple different preset workout routines, and cause resistance level change instructions to be communicated over time to the shopping cart control system 202 to cause modifications in resistance levels consistent with the first preset workout.

The cart coordination system, in some embodiments, is further configured to access a customer profile associated with a customer to determine one or more options and/or settings to apply. In some instances, for example, the cart coordination system may obtain, from a customer profile exclusively associated with the identified customer, a set of at least one initialization instructions defining at least an initial resistance level. An initialization instruction can be communicated to the cart control system (e.g., from the cart coordination system and/or the user interface unit) comprising the set of at least one initialization instructions, which may in some instances be communicated in response to associating the customer with the shopping cart. The initialization instructions cause the resistance modification system to set the resistance level to the initial resistance level. Other predefined settings can additionally or alternatively be defined and applied based on an identified customer (e.g., predefined distance, predefined duration, predefined resistance level, etc.). In some instances, subsequent workout instructions can be communicated, such as subsequent adjustments over time of the resistance level, which may depend on feedback from one or more sensors. Alternatively or additionally, a workout can be communicated to the cart control system providing instructions to be implemented over time to complete the workout. Such workout instructions can include thresholds corresponding to one or more events and/or sensor information (e.g., reaching a predefined distance, a heart rate, a duration, and other such events and/or sensor information).

Further, in some applications, the cart coordination system can provide routing through and/or proximate the shopping facility to meet one or more workout goals. The cart coordination system can obtain workout goals associated with a customer. These may be obtained based on a predefined workouts selected from a set of one or more predefined workers, goals specified by the customer (e.g., selected from a listing of potential goals and/or values set associated with different potential goals), or the like. Based on one or more goals, the cart coordination system and/or the cart control system may determine a route through the shopping facility to achieve at least part of one or more workout goals. Route instructions that the customer is to follow while pushing the shopping cart can be communicated to the cart control system and/or to a user interface unit 108 associated with the customer. The route instructions may be displayed and/or audibly presented through the user interface system 208 of the shopping cart system and/or the user interface unit. Additionally or alternatively, the route to be followed may further take into consideration products the customer intends to purchase and/or may want to purchase. The cart coordination system access a shopping list associated with the customer identifying one or more product desired by the customer, and can determine the routing to include directing the customer to a location within the shopping facility of each of the products identified in the shopping list. Similarly, the routing may consider products that the customer may be interested in purchasing and/or products the shopping facility is trying to enhance sales. In some embodiments, the cart coordination system considers customer partiality vectors and product partiality vectors in attempting to identify products a customer is more likely to be interested in purchasing. Partiality vectors and their use are further described in U.S. Provisional Application No. 62/323,026, filed Apr. 15, 2016, which is incorporated herein by reference in its entirety.

In some embodiments, the cart coordination system is configured to receive workout statistics. The statistics may be received from sensors 220 of the cart system, from the customers' user interface units 108, from shopping facility sensors (e.g., RFID tag readers, bar code readers, wireless network access nodes detecting user interface units, etc.), and/or other sources. For example, the statistics can include information corresponding to a distance traveled by the customer, one or more resistance levels, resistance levels corresponding to distances traveled while the first customer pushes a cart, heart rate, products in the cart, weight of products in the cart, and/or other such information. The distance traveled may be determined based on one or more sensors on the cart (e.g., cooperated with one or more wheels), the cart coordination system tracing movement of the customer and/or cart (e.g., through location information from the cart system, information from the user interface unit, information from one or more external sensors (e.g., RFID tag readers detecting the cart, bar code readers detecting barcodes on the cart, encoded lights detected by sensors on the cart and/or the user interface unit, etc.), and/or other such information. In some embodiments, the cart control system may include a GPS system, one or more inertial sensor systems and/or the like that provide information that can be used to track movement of the cart. GPS data, inertial data, Wi-Fi triangulation and/or other such information may additionally or alternatively be communicated by the user interface unit that can be used to track movement of the cart and/or customer. Similarly, the cart system may include heart rate monitoring pads (e.g., on the handle of the cart) that can detect heart rate through the customer's contact. Additionally or alternatively, a separate heart rate system (e.g., watch, chest strap, etc.) can communicate information (e.g., heart rate, number of steps, etc.) to the customer's user interface unit that can be used by the APP and/or can be relayed through the APP to the cart coordination system, and/or the heart rate system may directly communicate with the cart coordination system. In some embodiments, the cart control system and/or the cart coordination system track products loaded into the cart and/or the weight of these products. One or more product identifying systems may be cooperated with the cart (e.g., RFID tag reader, barcode reader, etc.), carried by the customer (e.g., user interface unit may operate as a barcode reader, a separate barcode or RFID tag reader, etc.), and/or be implemented separate from the cart system and user interface unit at the shopping facility (e.g., based on RFID tag readers in the ceiling, video analysis from cameras within the retail store, etc.). The product identifying systems can detect products placed into the cart and cause that information to be communicated (e.g., directly or through the user interface unit) to the cart coordination system 102, fitness service 120, user interface unit 108, cart system 110, and/or other such systems. The cart control system and/or the cart coordination system can be configured to take such load into account and provide a level of resistance, consistent with the user selected level and/or workout specified level, independent of cart load.

The cart coordination system and/or the cart control system can further adjust the workout route based on the workout statistics and the workout goals. Adjusted route instructions can be communicated to the cart control system and/or to the customer's user interface unit 108. Further, in some embodiments, the cart coordination system tracks the location of other carts being used by customers during workouts, other carts not being used for workouts and/or other customers. Using the location information and/or the tracked routes, the cart coordination system can modify workout routes based on the location and expected routes of other carts and/or customers. The modifications can be implemented to reduce congestion, reduce customer crossings, maintain a general directional flow, and/or other such modifications. The workout and/or resistance level may further be modified based on one or more factors (e.g., duration, time since last stopped, stop for more than a threshold, heart rate (which may be senses through sensors on the cart, communicated from a smartwatch or workout watch, etc.). For example, the cart control system and/or a central control system can utilize information from other carts, video processing, communications from other user interface units and/or other such information to determine congestion and modify routes of one or more carts in attempts to avoid and/or reduce congestion.

In some embodiments, the cart control system 202 is configured to communicate directly with the customer's user interface unit and/or the cart resistance control APP operated on the user interface unit. The cart control system can wirelessly receive, directly from the customer's user interface unit through the cart resistance control APP, a modification of the resistance level, and can cause a modification in the resistance level consistent with the received modification of the resistance level. Further, in some embodiments the customer's user interface unit can be utilized as the user interface of the cart system 110. Through direct wireless communication between the user interface unit and the cart control system, the customer can receive relevant information, selection options, input instructions and/or other such interaction with the cart control system. In some implementations, for example, a Bluetooth communication and/or cellular communication may be established between the user interface unit and the cart control system. In some instances, the user interface unit may capture identifying information of the cart and/or the cart control system that can be communicated to the cart control system in confirming a wireless coupling with the correct user interface unit. In other instances, the user interface unit may couple through wired coupling with the cart control system (e.g., mounted into a holder on the cart with a coupling interface to couple the user interface unit with the cart control system).

Further, the circuits, circuitry, systems, devices, processes, methods, techniques, functionality, services, servers, sources and the like described herein may be utilized, implemented and/or run on many different types of devices and/or systems. FIG. 3 illustrates an exemplary system 300 that may be used for implementing any of the components, circuits, circuitry, systems, functionality, apparatuses, processes, or devices of the cart workout system 100 of FIG. 1, the cart systems 110, and/or other above or below mentioned systems or devices, or parts of such circuits, circuitry, functionality, systems, apparatuses, processes, or devices. For example, the system 300 may be used to implement some or all of the central cart coordination system 102, the cart system 110, the cart control system 202, user interface units 108, an inventory system 116, a routing system 114, and/or other such components, circuitry, functionality and/or devices. However, the use of the system 300 or any portion thereof is certainly not required.

By way of example, the system 300 may comprise a control circuit or processor module 312, memory 314, and one or more communication links, paths, buses or the like 318. Some embodiments may include one or more user interfaces 316, and/or one or more internal and/or external power sources or supplies 340. The control circuit 312 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 312 can be part of control circuitry and/or a control system 310, which may be implemented through one or more processors with access to one or more memory 314 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 300 may be used to implement one or more of the above or below, or parts of, components, circuits, systems, processes and the like. For example, the system may implement the central cart coordination system 102 with the control circuit being a cart coordination control circuit, the cart control system with a cart control circuit, a user interface unit with a user interface unit control circuit, or other components.

The user interface 316 can allow a user to interact with the system 300 and receive information through the system. In some instances, the user interface 316 includes a display 322 and/or one or more user inputs 324, such as buttons, touch screen, track ball, keyboard, mouse, etc., which can be part of or wired or wirelessly coupled with the system 300. Typically, the system 300 further includes one or more communication interfaces, ports, transceivers 320 and the like allowing the system 300 to communicate over a communication bus, a distributed computer and/or communication network 106 (e.g., a local area network (LAN), the Internet, wide area network (WAN), etc.), communication link 318, other networks or communication channels with other devices and/or other such communications or combination of two or more of such communication methods. Further the transceiver 320 can be configured for wired, wireless, optical, fiber optical cable, satellite, or other such communication configurations or combinations of two or more of such communications. Some embodiments include one or more input/output (I/O) ports 334 that allow one or more devices to couple with the system 300. The I/O ports can be substantially any relevant port or combinations of ports, such as but not limited to USB, Ethernet, or other such ports. The I/O interface 334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 326 to provide information to the cart workout system 100 and/or the cart control system 202, and/or sensor information that is communicated to another component. The sensors can include substantially any relevant sensor, such as distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 300 comprises an example of a control and/or processor-based system with the control circuit 312. Again, the control circuit 312 can be implemented through one or more processors, controllers, central processing units, logic, software and the like. Further, in some implementations the control circuit 312 may provide multiprocessor functionality.

The memory 314, which can be accessed by the control circuit 312, typically includes one or more processor readable and/or computer readable media accessed by at least the control circuit 312, and can include volatile and/or nonvolatile media, such as RAM, ROM, EEPROM, flash memory and/or other memory technology. Further, the memory 314 is shown as internal to the control system 310; however, the memory 314 can be internal, external or a combination of internal and external memory. Similarly, some or all of the memory 314 can be internal, external or a combination of internal and external memory of the control circuit 312. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 106. The memory 314 can store code, software, executables, scripts, data, content, lists, programming, programs, log or history data, user information, customer information, product information, and the like. While FIG. 3 illustrates the various components being coupled together via a bus, it is understood that the various components may actually be coupled to the control circuit and/or one or more other components directly.

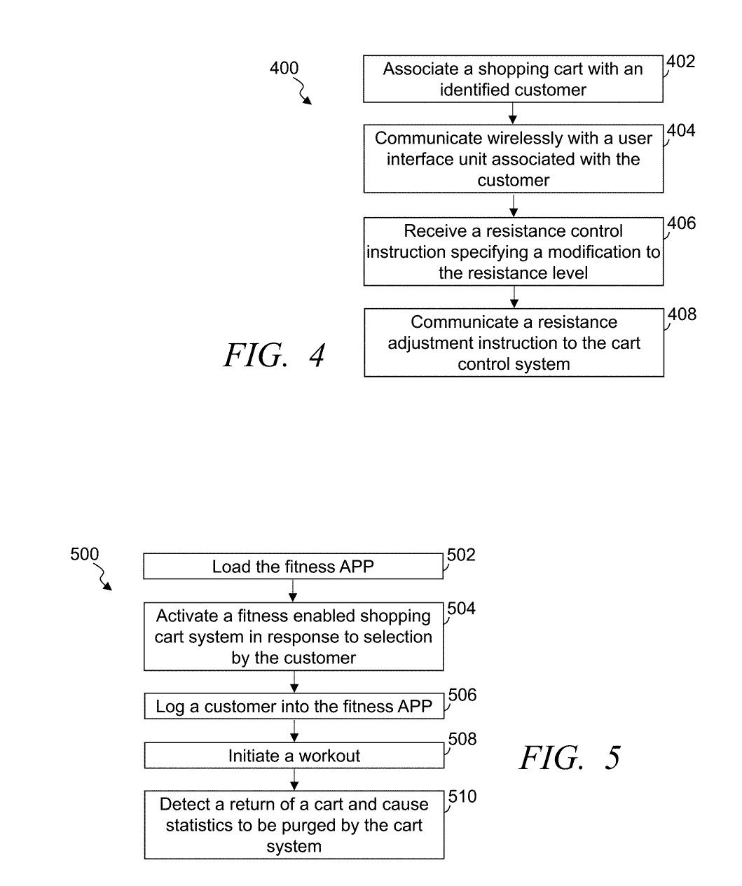

FIG. 4 illustrates a simplified flow diagram of an exemplary process 400 of providing customers with a workout while shopping, in accordance with some embodiments. The process can be implemented at one or more shopping facilities to facilitate customers trying to get exercise while at a shopping facility. In some instances, the process may be implemented, at least in part, through a cart coordination system 102 in cooperation with cart systems 110. In step 402, a shopping cart is associated with an identified customer. The cart may be identified through one or more methods, such as but not limited to RFID tag, barcode, identifier number detected by a system or entered through a customer, timing associated with an activation of an option by a customer (e.g., an APP on a customer's user interface unit may direct a customer regarding when to select a button or other activation that causes a communication that can be associated with the user interface unit, the APP and/or the customer), customer can enter an identifier through the APP, or other such methods. For example, some implementations receive, through the cart resistance control APP operating on the customer's user interface unit, a cart identifier of the shopping cart, and implement the associating of the shopping cart with the first customer based on the received cart identifier. Typically, the shopping cart comprises a cart control system 202 and a resistance modification system 204 configured to adjust a resistance level corresponding to different amounts of force to be applied in physically moving the cart along a surface.

In step 404, wirelessly communication is established with a user interface unit associated with the customer. This communication may be based on a communication initiated through a cart resistance control software, through the cart coordination system identifying the customer (e.g., through an RFID tag carried by the customer, a scan of a customer's credit card or shopping facility card, etc.), accessing contact information (e.g., phone number, MAC address, etc.) through a customer profile, other such methods, or combination of such methods. In step 406, one or more instructions are received through the cart resistance control APP operated on the customer's user interface unit and/or a user interface system 208 of the cart system 110. The one or more instructions may include, for example, a resistance control instruction specifying a modification to the resistance level, a selection of one of a set of multiple different predefined workouts, a specified workout duration, identification of one or more products to be retrieved while performing the workout, requested change to a predefined workout or duration, pause the workout, resume the workout, stop the workout, other such instructions, or combination of such instructions. In step 408, a resistance adjustment instruction is communicated to the cart control system causing the resistance modification system to adjust the resistance level applied to the shopping cart in accordance with the received instruction, based on a workout, and the like.

Further, some embodiments obtain, from a first customer profile exclusively associated with the customer, a set of at least one initialization instructions defining one or more workout parameters and/or settings, such as but not limited to an initial resistance level, an initial distance, an initial routing, etc. One or more initialization instructions can be communicated to the shopping cart control system comprising the set of at least one initialization instructions, which may in some instances be communicated in response to associating the customer with the shopping cart. The instruction can be implemented by the cart control system, resistance modification system, the user interface system or other system of the cart system. For example, the instruction to set the initial resistance level may cause the resistance modification system 204 to set the resistance level to the initial resistance level. Similarly, in some embodiments the cart coordination system 102 may receive, though the cart resistance control APP, a selection of a preset workout routine selected from multiple different preset workout routines. Resistance level change instructions can be caused to be communicated over time to the shopping cart control system to cause modifications in resistance levels consistent with the selected preset workout. In other instances, a set of resistance level change instructions and corresponding implementation parameters (e.g., timing, distance traveled, heart rate, durations at corresponding threshold heart rates, etc.) may be communicated to the cart control system, and the cart control system can direct the resistance modification system in accordance with the timing and/or based on other workout statistics.

In some embodiments, workout goals associated with the customer are obtained, and a route through the shopping facility is determined to achieve at least part of the workout goals. One or more or a set of route instructions that the customer is to follow while pushing the shopping cart can be communicated to the customer's user interface unit and/or the cart system to be presented (e.g., displayed and/or audibly rendered) through the user interface of the user interface unit and/or the user interface system 208 of the cart system. In some instances, the route can be determined in part by accessing a shopping list associated with the customer that identifies at least one product desired by the customer (e.g., through a customer profile, supplied through the cart resistance control APP or other APP associated with the shopping facility) and/or provides that the customer may be interested in purchasing (e.g., determined based on shopping history, determined based on partiality vectors, other such information, or combination of two or more of such sources of information). The determined routing can include directing the first customer to a location within the shopping facility of each of the one or more products identified in the shopping list and/or determined that the customer may be interested in purchasing. Further, the routing may often include an indirect route to the one or more products to achieve the desired distance and/or workout duration. Cart feedback (and/or user interface unit feedback) can be used to identify how far a customer has traveled, workout levels (e.g., distance+resistance level(s)) and the like in determining and/or modifying a route.

Some embodiments receive workout statistics. The statistics can include statistics corresponding to at least distances traveled by the customer, resistance levels corresponding to the distances traveled while the customer pushes the cart, heart rate, perspiration levels, location, and other such information. The workout and/or the routing can be adjusted based on the workout statistics and the workout goals. Adjusted route instructions and/or resistance levels to the user interface unit and/or the cart control system. Further, some embodiments receive, though the cart resistance control APP, a modification of the resistance level. The modifications maybe received at the cart coordination system, which can communicate a resistance level change instruction to the shopping cart control system to cause a modification in the resistance level consistent with the received modification of the resistance level. In other instances, the resistance modification request may be received at the cart control system (e.g., though the user interface system 208, a direct communication from the customer's user interface unit, or the like. Accordingly, some embodiments wirelessly receiving, at the cart control system and directly from the customer's user interface unit through the cart resistance control APP, a modification of the resistance level. The cart control system can cause a modification in the resistance level consistent with the received modification of the resistance level.

FIG. 5 illustrates a simplified flow diagram of an exemplary process 500 to enable customers to perform a workout while at a shopping facility, in accordance with some embodiments. In step 502, the fitness and/or resistance control APP is loaded onto a customer's user interface unit. In some instances, the customer agrees to terms and conditions. Further, in some applications, the APP directs the customer to register the customer device and/or APP with the cart coordination system and/or a central control system, such as associating the APP with a customer profile. In step 504, the customer at the shopping facility selects a fitness enabled cart system 110 and the shopping cart system is initiated and activated. In step 506, the customer is logged into the fitness APP using her/his user interface unit or a user interface system 208 of the cart system. The login may include selecting a workout routine, setting a resistance level, or the like. Additionally or alternatively, the customer may access a user interface of the APP to select one or more workout parameters.

In step 508, the desired workout is initiated. In some instances the customer initiates the desired workout. When desired the workout can include the customer shopping through the shopping facility for one or more products. The APP and/or cart control system and/or the cart coordination system can track one or more workout statistics (e.g., resistance levels and corresponding durations or distances, estimated calories burned, estimated number of steps taken, etc.). In some instances, the APP enables the customer to enter relevant personal information to allow the system to track estimated calories burned (e.g., weight, height, age, etc.). In step 510, the system detects the return of the cart to a cart corral or other location by the customer. In some instances, this concludes the workout, while in other instances the customer may continue the workout without the cart (e.g., continue walking through the shopping facility, moving to a workout area to perform other exercises (e.g., push-ups, abdominal exercises, lunges, etc.)), which may be directed by the selected workout routine. In some embodiments, workout statistics is purged from the cart control system 202 and/or user interface system 208. The cart coordination system and/or APP may cause statistics to be stored and tracked over time, used to determine subsequent workout routines and/or settings, and the like.

In some embodiments, the resistance modification system may automatically be reset to a zero, lowest or predefined resistance threshold upon one or more actions or occurrences. For example, the reset may be activated upon detection of disabling the APP, after a threshold period of time without movement, upon cart control system detecting it has left the shopping facility and/or traveled a threshold distance from the shopping facility, after detecting the cart has passed a point of sales system, after detecting products have been removed, after detecting (e.g., RFID) the cart has be placed into a cart corral or being notified by the cart coordination system (e.g., RFID reader at corral), or the like. Additionally or alternatively, workers of the shopping facility may reset the cart system, such as through a worker RFID chip (e.g., on name tag) detected to cause a reset to a zero resistance level. In other instances, workers may carry or have access to one or more worker user interface units, which may be personal devices (e.g., workers smartphone, tablet, etc.) and/or a shopping facility supplied user interface unit (e.g., smartphone, communication system, scanner, etc.) that further is configured to communicate with the cart control system 202 and/or the cart coordination system 102. The worker user interface unit can at least direct control of the resistance modification system 204, such as when the worker identifies and/or retrieves an abandoned cart that is equipped with the workout and/or resistance modification system. The worker can reset or set the resistance level to a zero or lowest resistance level, which can be advantageous when collecting carts. In some instances, the generator 216 may operate in a reverse order and/or include a motor that can help the worker to move the cart. Similarly, the worker user interface system can cause a rest of the workout statistics on the control system, and may further notify the cart coordination system that the cart is free for use for another customer.

Some embodiments provide systems that can employ shopping cart systems that can be controlled through a fitness and/or resistance modification APP. In some instances, the APP, cart coordination system and/or the cart control system can track workout statistics, measure calories burned during shopping, and/or other such information. In some embodiments, the cart system includes a power generator 216 that is driven off one or more of the cart's wheels and/or the resistance modification system. The generated power can be used to charge a power source 212 (e.g., battery, capacitor, etc.) on the cart and/or charge a customer's user interface unit 108 that is cooperated with a docking station on the cart. The system can be configured to allow a customer to increase or decrease the cart's rolling resistance in order to obtain the requested level of exercise. In some embodiments, the cart control system and/or the cart coordination system track products loaded into the cart and/or the weight of these products. The cart control system and/or the cart coordination system can be configured to take such load into account and provide a level of resistance, consistent with the user selected level and/or workout specified level, independent of cart load.

The system, in some embodiments, utilized and/or communicates with the fitness and/or resistance control APP, which may be configured to measure calories burned during a shopping facility workout. In some embodiments, the generator can be driven by one or more of the cart's wheels, and the generated power can be used, in some instances, to charge a power source 212 on the cart and/or charge a customer's user interface system when docked in the docking station. In some instances, the system allows customers to increase or decrease the rolling resistance in order to obtain the requested level of exercise. Additionally or alternatively, the system can apply a workout routine that autonomously adjusts the resistance in accordance with the workout routine and/or level of workout selected by the customer. Further, the cart coordination system and/or the cart control system can control the resistance to provide a desired resistance level and/or a constant resistance level independent of cart load.

In some embodiments, systems and a corresponding methods are provided to provide retail customers with a workout while at a retail store or shopping facility. Some embodiments provide a retail customer controlled cart workout system, comprising: a cart coordination control circuit; a shopping cart comprising a cart control system, a wireless transceiver and a resistance modification system cooperated with wheels of the cart and configured to adjust a resistance level corresponding to different amounts of force to be applied in physically moving the cart along a surface; wherein the cart coordination control circuit is configured to: associate the shopping cart with a first identified customer; wirelessly communicate with a first user interface unit associated with the first customer; receive, through a cart resistance control software application (APP) operated on the first user interface unit, a resistance control instruction specifying a modification to the resistance level; and communicate a resistance adjustment instruction to the cart control system causing the resistance modification system to adjust the resistance level applied to the shopping cart.

Further, some embodiments provide methods of providing retail customers with a workout while shopping at a retail store, comprising: by a cart coordination control circuit: associating a shopping cart with a first identified customer, wherein the shopping cart comprises a cart control system and a resistance modification system cooperated with wheels of the cart and configured to adjust a resistance level corresponding to different amounts of force to be applied in physically moving the cart along a surface; communicating wirelessly with a first user interface unit associated with the first customer; receiving, through a cart resistance control software application (APP) operated on the first user interface unit, a resistance control instruction specifying a modification to the resistance level; and communicating a resistance adjustment instruction to the cart control system causing the resistance modification system to adjust the resistance level applied to the shopping cart.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A customer controlled retail cart workout system, comprising:
a cart coordination control circuit;
a shopping cart comprising a cart control system, a wireless transceiver, and a resistance modification system configured to adjust a resistance level corresponding to different amounts of force to be applied in physically moving the cart along a surface;
wherein the cart coordination control circuit is configured to:
associate the shopping cart with a first identified customer;
wirelessly communicate with a first user interface unit associated with the first customer;
receive, through a cart resistance control software application (APP) operated on the first user interface unit, a resistance control instruction specifying a modification to the resistance level; and
communicate a resistance adjustment instruction to the cart control system causing the resistance modification system to adjust the resistance level applied to the shopping cart.

2. The system of claim 1, wherein the cart coordination control circuit is further configured to obtain, from a first customer profile exclusively associated with the first customer, a set of at least one initialization instructions defining at least an initial resistance level, and to communicate an initialization instruction comprising the set of at least one initialization instructions to the cart control system in response to associating the first customer with the shopping cart, and causing at least the resistance modification system to set the resistance level to the initial resistance level.

3. The system of claim 1, wherein the cart coordination control circuit is further configured to receive, through the cart resistance control APP operating on the first user interface unit, a cart identifier of the shopping cart, and implement the associating of the shopping cart with the first customer based on the received cart identifier.

4. The system of claim 1, wherein the cart coordination control circuit is configured to obtain workout goals associated with the first customer, determine a route through the shopping facility to achieve at least part of the workout goals, and communicate route instructions to the first user interface unit that the first customer is to follow while pushing the shopping cart.

5. The system of claim 4, wherein the cart coordination control circuit in determining the route is configured to access a shopping list associated with the first customer identifying at least one product desired by the customer and determines the routing to include directing the first customer to a location within the shopping facility of each of the at least one product identified in the shopping list.

6. The system of claim 4, wherein the cart coordination control circuit is configured to receive workout statistics corresponding to at least distances traveled by the customer and resistance levels corresponding to the distances traveled while the first customer pushes the cart, adjust the route based on the workout statistics and the workout goals, and communicate adjusted route instructions to the first user interface unit.

7. The system of claim 1, wherein the cart coordination control circuit is configured to: receive, though the cart resistance control APP, a selection of a first preset workout routine selected from multiple different preset workout routines, and cause resistance level change instructions to be communicated over time to the cart control system to cause modifications in resistance levels consistent with the first preset workout.

8. The system of claim 1, wherein the cart coordination control circuit is configured to: receive, though the cart resistance control APP, a modification of the resistance level, and communicate a resistance level change instruction to the cart control system to cause a modification in the resistance level consistent with the received modification of the resistance level.

9. The system of claim 1, wherein the cart control system is configured to wirelessly receive directly from the first user interface unit through the cart resistance control APP a modification of the resistance level, and causes a modification in the resistance level consistent with the received modification of the resistance level.

10. A method of providing retail customers with a workout while shopping at a retail store, comprising:
by a cart coordination control circuit:
associating a shopping cart with a first identified customer, wherein the shopping cart comprises a cart control system and a resistance modification system configured to adjust a resistance level corresponding to different amounts of force to be applied in physically moving the cart along a surface;
communicating wirelessly with a first user interface unit associated with the first customer;
receiving, through a cart resistance control software application (APP) operated on the first user interface unit, a resistance control instruction specifying a modification to the resistance level; and
communicating a resistance adjustment instruction to the cart control system causing the resistance modification system to adjust the resistance level applied to the shopping cart.

11. The method of claim 10, further comprising:
obtaining, from a first customer profile exclusively associated with the first customer, a set of at least one initialization instructions defining at least an initial resistance level; and
communicating an initialization instruction comprising the set of at least one initialization instructions to the cart control system in response to associating the first customer with the shopping cart, and causing at least the resistance modification system to set the resistance level to the initial resistance level.

12. The method of claim 10, further comprising:
receiving, through the cart resistance control APP operating on the first user interface unit, a cart identifier of the shopping cart; and
implementing the associating of the shopping cart with the first customer based on the received cart identifier.

13. The method of claim 10, further comprising:
obtaining workout goals associated with the first customer;
determining a route through the shopping facility to achieve at least part of the workout goals; and
communicating route instructions to the first user interface unit that the first customer is to follow while pushing the shopping cart.

14. The method of claim 13, wherein the determining the route comprises:
accessing a shopping list associated with the first customer identifying at least one product desired by the customer and determining the routing to include directing the first customer to a location within the shopping facility of each of the at least one product identified in the shopping list.

15. The method of claim 13, further comprising:
receiving workout statistics corresponding to at least distances traveled by the customer and resistance levels corresponding to the distances traveled while the first customer pushes the cart;
adjusting the route based on the workout statistics and the workout goals; and
communicating adjusted route instructions to the first user interface unit.

16. The method of claim 10, further comprising:
receiving, though the cart resistance control APP, a selection of a first preset workout routine selected from multiple different preset workout routines; and
causing resistance level change instructions to be communicated over time to the cart control system to cause modifications in resistance levels consistent with the first preset workout.

17. The method of claim 10, further comprising:
receiving, though the cart resistance control APP, a modification of the resistance level; and
communicating a resistance level change instruction to the cart control system to cause a modification in the resistance level consistent with the received modification of the resistance level.

18. The method of claim 10, further comprising:
wirelessly receiving, at the cart control system and directly from the first user interface unit through the cart resistance control APP, a modification of the resistance level, and causing, through the cart control system, a modification in the resistance level consistent with the received modification of the resistance level.
